(19) United States
(12) Patent Application Publication
(10) Pub. No.: US 2002/0144846 A1
(43) Pub. Date: Oct. 10, 2002

(54) Device to move an occupied chair

(76) Inventor: Kenneth S. Darby, Falls, PA (US)

Correspondence Address: Kenneth S. Darby, RRI Box 311, Falls, PA, 18615, US

(21) Appl. No.: 09/791,155

(22) Filed: Feb. 20, 2001

(51) Int. Cl. B60K 1/00; B62D 33/08

(52) U.S. Cl. 180/65.1; 280/43.15; 280/43.23

(57) ABSTRACT

A device to aid in moving an occupied chair to or from a table. The device enables a senior citizen or a handicapped individual to easily raise the chair onto wheels and roll him or herself to or from the table. The same device enables a caregiver, standing behind the chair, to easily raise the occupied chair to enable it to be rolled to or from the table.

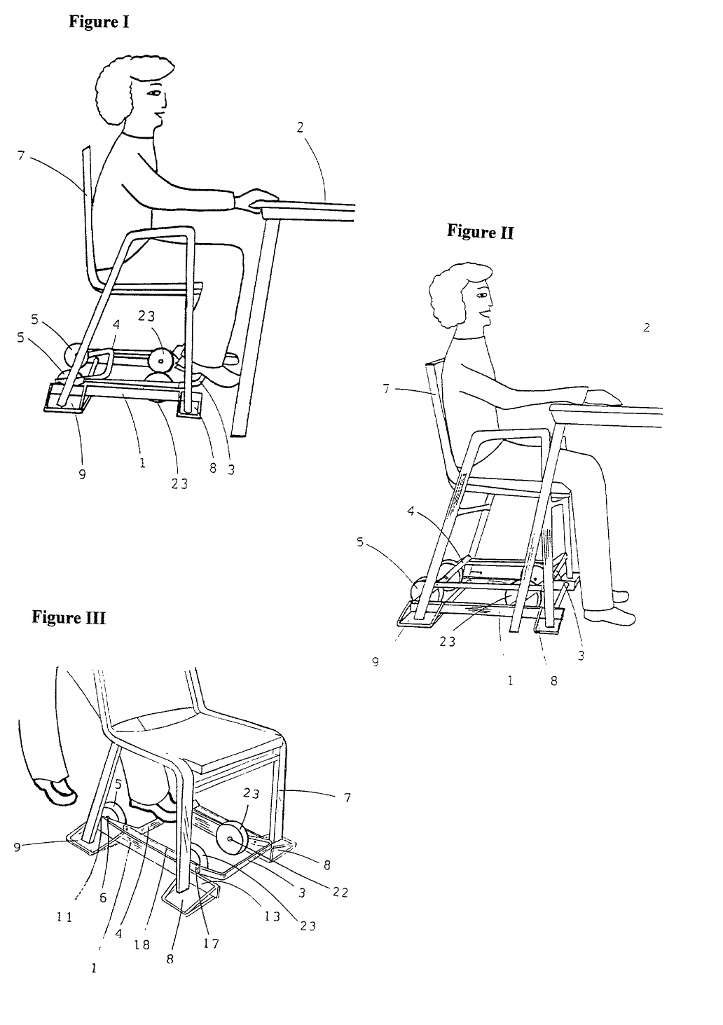

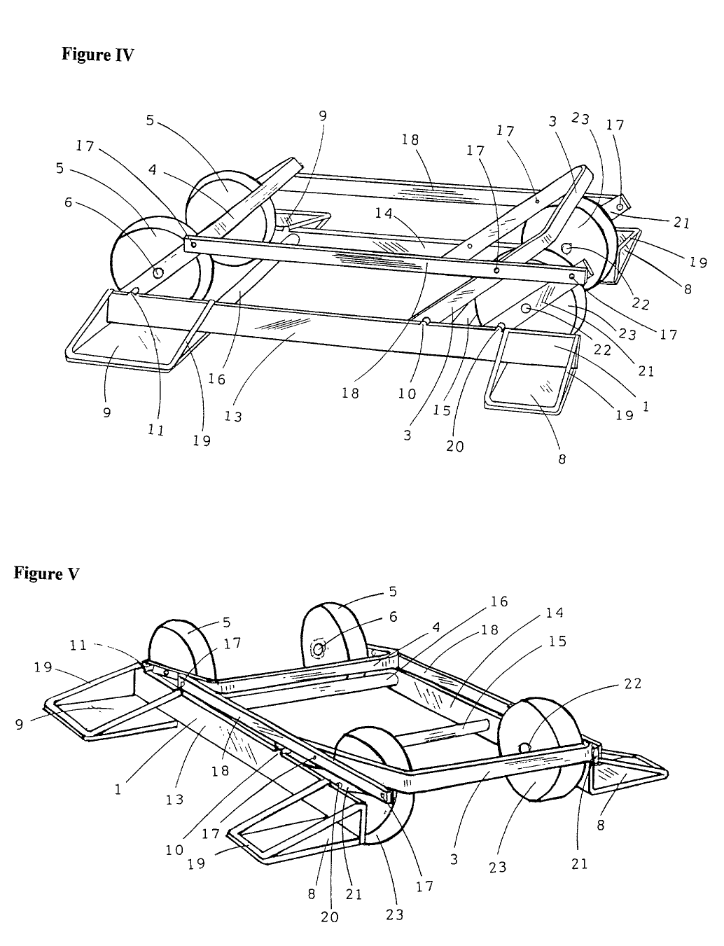

### FIELD OF INVENTION

Senior citizens and disabled people often have a problem after they sit at a table because they cannot lift and move their chair to or from the table. There is a need for a device that will aid a person on a chair or a caregiver to lift and roll the chair to or from a table.

### BACKGROUND OF THE INVENTION

When a disabled person or a senior citizen is seated at a table, but cannot move his or herself closer to the table, food is often dropped onto this individuals lap or onto the floor. There is a need to enhance the ability of the individual to be independent and move him or herself to or from the table and to aid the caregiver in moving the occupied chair.

Thus it will improve the quality of life for the handicapped person in the chair.

Caregivers lift and move these occupied chairs and in many cases have injured their backs or knees in doing this.

This problem is sometimes addressed by using caster wheels permanently attached to a chair. While this will allow ease of movement to and from the table, a dangerous situation may occur. A chair equipped with caster wheels may move when a person attempts to sit down or stand up. Chair movement at this time could cause a person to fall.

Needed is a device to allow a person to move him or herself to and from the table, it also needs to provide a secure, stable chair to sit down on or stand up from.

### OBJECTS OF THIS INVENTION

This device is to aid in moving an occupied chair to or from a table. This device provides a means for an individual to move to and from a table and not feel that he or she is disabled or handicapped when seated at a table. Also this present invention eliminates the potential back and knee injury to caregivers who help move the individual seated on a chair. This two-in-one device is designed for the occupant to move his or herself on a chair or for the caregiver to move the individual on the chair. This device can support and aid in moving most four legged chairs used in the dining room.

### SUMMARY

This present invention will enhance the ability of an individual to be independent and by aiding him or herself to and from a table. This device also can aid the caregiver in moving a handicapped or disabled individual sitting on a chair to or from the table. This device has four platforms that are connected to the frame and support the chair's legs. These platforms are large enough to accommodate standard four legged chairs. This device has wheels that are connected to levers that pivot from the frame and lift the frame and chair platforms when these levers are depressed. There is a lever near the front that is accessible by the foot of the individual on the chair and a lever near the rear accessible by the caregiver's foot when he or she is standing behind the chair.

### BRIEF DESCRIPTION OF THE DRAWINGS

Figure I: Illustrates an individual sitting on a chair supported by this device and rolling his or herself up to the table.

Figure II: Illustrates an individual sitting at the table when this device supporting the chair is firmly on the floor.

Figure III: Illustrates moving the chair supported by this device when the caregiver operates it from behind.

Figure IV: Illustrates this device when the platforms are firmly on the floor and the wheels are raised.

Figure V: Illustrates this device raised on to the wheels ready to be rolled.

Reference to Numeral and Drawings:

1-Device
2-Table
3-Front Lever Bar
4-Rear Lever Bar
5-Rear Wheels
6-Rear Axel
7-Chair
8-Front Platforms
9-Rear Platforms
10-Middle Bearing
11-Rear Bearings
12-Device Frame
13-Right Side Frame
14-Left Side Frame
15-Front Cross Member
16-Rear Cross Member
17-Connector Bearing
18-Connector Bar
19-Railing
20-Front Bearing
21-Front Axel Lever
22-Front Axel
23-Front Wheels

### DETAILED DESCRIPTION ON THE DRAWING

Figure I: Illustrates one embodiment of this device with an occupant sitting on the chair (7) pushing down on the front lever bar (3) which raises the device (1) onto the wheels (5 & 23) to allow it to be rolled to or from the table (2). The chair (7) rests on the front platforms (8) and the rear platforms (9). When either the front lever (3) or rear lever (4) is pushed downward the wheels (5 & 23) extend below the device (1) and allow it, with the chair (7), to be rolled.

Figure II: Illustrates the individual sitting at the table (2) on the chair (7) that is firmly in place with the front legs on the front platforms (8) and the rear legs on the rear platforms (9). This device (1) sits firmlv on the floor when the front lever bar (3) and rear lever bar (4) are in the up position. In this position the wheels (5 & 23) are held above the floor.

Figure III: Illustrates a caregiver moving the chair (7) supported by this device (I). To move a chair (7) to or from the table (2) the caregiver pushes the rear lever bar (4) downward which swivels around the rear bearing (I 1) and forces down the wheels (5 & 23) mounted on the axels (6 & 22) to raise the device (1) with platforms (8 & 9) raising the chair (7) to be rolled.

Figure IV: Illustrates one embodiment of the device (1) with the front wheels moved forward for better stability consisting of a right side frame (13) and a left side frame (14) connected with front cross member (15) and rear cross member (16). The two front platforms (8) are rigidly connected to the right side frame (13) and the left side frame (14). The two rear platforms (9) are connected to the right side frame (13) and the left side frame (14). This rigid frame assembly has a front bearing (20) and a middle bearing (10), and a rear bearing (11) on right side frame (13) and on left side frame (14). One end of each of the two U shaped levers (3 & 4) swivel on four bearings (10 & 11). Two front axel levers (21) swivel on bearings (20) near the front and are connected to connector bar (18). This allows all three levers (3, 4, & 21) to move parallel to each other when the connector bar (18) moves. About one fifth of the ways up the levers (4 & 21) the axels (6 & 22) are attached and support the wheels (5 & 23). The levers (3 & 4) continue about four fifths more to provide a leverage advantage and join the other side of the U shaped levers (3 & 4). In this drawing the device (1) is sitting firmly on the floor with the wheels (5 & 23) raised. The wheels (5) are mounted on axels (6), which are attached to the U shaped lever (4). The front axel (22) with front wheels (23) are attached to the front axel lever (21) and connected to the connecting bar (18) at bearing (17). The levers (3, 4, & 21) are joined by a connecting bar (18) near the far end at bearings (17). This parallelogram with three lever bars (3, 4, & 21) provide a means to locate the front axel (22) and wheels (23) close to the front of the main frame (1) and a means for lever (3) to be positioned so the downward force needed to push axel (22) and wheels (23) downward almost in the same vertical plane as the lever (3). This is done to provide support so that an individual leaning forward and pulling him or herself up to a table will not tip forward. The connecting bars (I 8) form a parallelogram with the side frames (13 & 14) and levers (3, 4, & 21) to operate all four wheels (5 & 23) at the same time. When the lever bars (3 & 4) are in the up position the axels (6 & 22) raise the wheels (5 & 23) to allow this device (1) to rest its platforms (8 & 9) on the floor. Each of the four platforms (8 & 9) has a railing (19) on the front, side, and back to keep the chair (7) legs from sliding off.

Figure V: Illustrates one embodiment of the device (1) in the raised position with the wheels (5) supporting the device (1). This drawing illustrates the form the device (1) takes when the levers (3 or 4) are pushed downward forcing the lever (21) with the axel (22) and front wheels (23) along with rear axel (6) and rear wheels (5) to extend below the device (1) and platforms (8 & 9) to raise the device (1) and the chair (7) it is supporting to be easily rolled.

What I claim is:

1. A device to aid a disabled or handicapped person, when seated on a chair, in moving the chair up to or from the table. The 4 legs of the chair placed on the platforms of this device can rest securely on the floor or the weight can be transferred onto the wheels when the occupant of the chair pushes his or her foot on the front lever or when the caregiver pushes on the rear lever to lift and roll the chair. These levers are connected to the axels of the 4 wheels the frame of the device and a connecting rod to form a parallelogram and place the weight on all 4 wheels at one time.

2. The device in claim 1 with a dual lever system or a triple lever system to allow the front wheels closer to the front end for better stability.

3. This device described in claim 1 having an electric linear actuator to supply the push to the lever and transfer the weight to the wheels when the occupant energizes it to allow rolling to or from the table.

4. The device described in claim 2 with a drive motor to assist in rolling as well as transferring the weight to the wheels.
